(19) United States
(12) Patent Application Publication
(10) Pub. No.: US 2013/0277222 A1
(43) Pub. Date: Oct. 24, 2013

(54) WATER TREATMENT APPARATUS AND WATER TREATMENT METHOD USING THE SAME

(71) Applicants: Claude Kwon, Seoul (KR); Young-Gun Cho, Seoul (KR); Soon-Ho Lim, Seoul (KR); Hyoung-Min Moon, Seoul (KR); Soo-Young Lee, Seoul (KR); Ui-Son Hwang, Seoul (KR)

(72) Inventors: Claude Kwon, Seoul (KR); Young-Gun Cho, Seoul (KR); Soon-Ho Lim, Seoul (KR); Hyoung-Min Moon, Seoul (KR); Soo-Young Lee, Seoul (KR); Ui-Son Hwang, Seoul (KR)

(73) Assignee: COWAY CO., LTD., Chungcheongnam-do (KR)

(21) Appl. No.: 13/996,414

(22) PCT Filed: Dec. 29, 2011
(86) PCT No.: PCT/KR2011/010328

§ 371 Date: Jun. 20, 2013

(30) Foreign Application Priority Data
Dec. 30, 2010 (KR) 10-2010-0138541
Dec. 26, 2011 (KR) 10-2011-0142566

(51) Int. Cl. C02F 1/469

(52) U.S. Cl. CPC C02F 1/4691
USPC 204/555; 204/663; 204/661

(57) ABSTRACT

A water treatment apparatus is provided. In the water treatment apparatus, a filter unit includes a first electrochemical filter and a second electrochemical filter for filtering raw water. A control unit drives the first electrochemical filter and the second electrochemical filter. The first electrochemical filter and the second electrochemical filter are installed in parallel. The control unit controls the second electrochemical filter to perform a water purifying operation when the first electrochemical filter needs to be recycled.

### TECHNICAL FIELD

The present invention relates to a water treatment apparatus and a water treatment method using the same, and more particularly, to a water treatment apparatus, capable of operating continuously even during a recycling of an electrochemical filter, without stopping a water purifying operation, and a water treatment method using the same.

### BACKGROUND ART

As industrialized societies have developed, pollution of natural environments, such as water pollution and soil pollution, has increased. Therefore, in these societies, raw water is commonly taken, purified, and then supplied to users. The widespread use of water purifiers in homes to purify tap water and supply clean drinking water is a recent trend.

Such water purifiers are designed to purify and sterilize a variety of impurities or bacteria remaining in tap water. In this regard, a reverse osmosis (RO) water purifier has been introduced, and a method of purifying water through a sterilizing process using an ultraviolet (UV) sterilization lamp has also been widely employed. This water purifier is provided with a membrane filters for removing pollutants, heavy metals, and/or bacteria from raw water supplied thereto.

A reverse osmosis water purifier may have much higher water purification efficiency than a general water purifier using a non-membranous filter. However, the reverse osmosis water purifier requires an appropriate amount of water pressure in raw water so as to obtain a predetermined level of purification of the raw water. Also, since a flow rate of purified water may be very low, the reverse osmosis water purifier may be provided with a storage tank, and supply water stored therein as purified water. Accordingly, the reverse osmosis water purifier may have several problems, for example, a secondary pollution of stored water due to airborne bacteria, the necessity of cleaning a polluted membrane, and the requirement for the periodic replacement of a membrane.

In order to solve these problems of conventional desalination techniques, a capacitive deionization (CDI) process using a principle of an electric double-layer has recently been studied and applied to a desalination process.

FIG. 1 is a schematic view of a CDI process. A CDI process uses a feature in which ions of opposite polarity are adsorbed on electrode surfaces in the water when electricity is applied to the electrode surfaces, based on a principle of an electric double-layer used in a capacitor process. As illustrated in a water purifying operation of FIG. 1, ions contained in an aqueous solution are removed by applying an electrostatic force when a solution containing cations and anions flows between two porous carbon electrode layers.

As described above, the CDI process uses an ion adsorption reaction by electrical attraction in an electric double-layer formed on an electrode surface when a potential is applied thereto. Therefore, the CDI process is seen as a next generation low-energy-dissipation desalination process as it is operable at a low electrode potential (about 1-2 V), and thus, energy dissipation is considerably low, as compared to other desalination processes.

A CDI electrode structure used in the CDI process includes a multi-layer cell manufactured by forming a positive electrode and a negative electrode to have flat plate shapes, and inserting a spacer therebetween such that water flows therethrough.

In addition, as illustrated in FIG. 1, a water purification system using this CDI process may perform a water purifying operation and a recycling operation merely by exchanging electrode polarities.

Furthermore, a cation exchange resin 20 is provided in the negative electrode, and an anion exchange resin 10 is provided in the positive electrode. Therefore, cations and anions in the water may be removed in an exchange process.

The cation exchange resin 20 may be exchanged with cations adsorbed on the negative electrode, and the anion exchange resin 10 may be exchanged with anions adsorbed on the positive electrode.

However, in the case of such a CDI cell, as described in the recycling operation of FIG. 1, it may be necessary to perform the recycling operation of removing materials adsorbed on the electrodes, after a water purifying operation has been partially performed. Therefore, it may be difficult to continuously extract purified water, and a user may not be able to be supplied with purified water during the recycling operation.

### DISCLOSURE OF INVENTION

### Technical Problem

An aspect of the present invention provides a water treatment apparatus, which can easily perform an exchange operation, without stopping an operation of a water purification apparatus employing electrochemical filters, and a water treatment method using the same.

Another aspect of the present invention provides a water treatment apparatus, which can operate continuously and can be manufactured to have a small size, and a water treatment method using the same.

### Solution to Problem

According to an aspect of the present invention, there is provided a water treatment apparatus, including: a filter unit comprising a first electrochemical filter and a second electrochemical filter for filtering raw water; and a control unit driving the first electrochemical filter and the second electrochemical filter, wherein the first electrochemical filter and the second electrochemical filter are installed in parallel, and the control unit controls the second electrochemical filter to perform a water purifying operation when the first electrochemical filter needs to be recycled.

The control unit may control the first electrochemical filter to perform a water purifying operation when the second electrochemical filter needs to be recycled.

When the first electrochemical filter performs the recycling operation, the control unit may control the second electrochemical filter to perform the water purifying operation. When the first electrochemical filter completes the recycling operation, the control unit may control the first electrochemical filter to perform the water purifying operation.

The first electrochemical filter and the second electrochemical filter may be configured such that the recycling of the second electrochemical filter has been completed while the first electrochemical filter performs the water purifying operation.

The point in time at which the electrochemical filter is recycled may be determined based on an elapsed electrochemical filter water purification time, a total dissolved solid (TDS) value of the purified water filtered by the electrochemical filter, or a current value of the purified water filtered by the electrochemical filter.

A capacity of the second electrochemical filter may be lower than a capacity of the first electrochemical filter.

The water treatment apparatus may further include: a first outflow pipe through which water having passed through the first electrochemical filter is discharged; a second outflow pipe through which water having passed through the second electrochemical filter is discharged; a purified water pipe connected to the first outflow pipe and the second outflow pipe and through which the purified water flows; and a drain pipe connected to the first outflow pipe and the second outflow pipe and through which waste water generated during the recycling of the electrochemical filter is discharged to the exterior.

The water treatment apparatus may further include: a first flow passage switch valve, provided at a branch point to which the first outflow pipe, the purified water pipe, and the drain pipe are connected, to selectively connect the first outflow pipe to the purified water pipe or the drain pipe; and a second flow passage switch valve, provided at a branch point to which the second outflow pipe, the purified pipe, and the drain pipe are connected, to selectively connect the second outflow pipe to the purified water pipe or the drain pipe.

When the first electrochemical filter performs the water purifying operation and the second electrochemical filter performs the recycling operation, the control unit may switch a flow passage of the first flow passage switch valve such that water flowing out from the first outflow pipe is supplied to the purified water pipe, and may switch a flow passage of the second flow passage switch valve such that water flowing out from the second outflow pipe is discharged to the drain pipe.

When the second electrochemical filter performs the water purifying operation and the first electrochemical filter performs the recycling operation, the control unit may switch a flow passage of the second flow passage switch valve such that water flowing out from the second outflow pipe is supplied to the purified water pipe, and may switch a flow passage of the first flow passage switch valve such that water flowing out from the first outflow pipe is discharged to the drain pipe.

When switching the water purifying operation and the recycling operation between the first electrochemical filter and the second electrochemical filter, the control unit may perform a switching operation, such that the electrochemical filter performing the water purifying operation continues to perform the water purifying operation for a predetermined period of time, and the flow passage switch valve provided at the branch point of the outflow pipe connected to the electrochemical filter being recycled may be switched in a direction of the purified water pipe after a preset period of time has elapsed, in order that waste water remaining in the outflow pipe connected to the electrochemical filter being recycled is discharged through the drain pipe.

When the first electrochemical filter performs the recycling operation, the control unit may supply an amount of the purified water filtered by the second electrochemical filter to the first electrochemical filter for recycling the first electrochemical filter.

The water treatment apparatus may further include: a flow passage switch valve provided at a position from which a first connection pipe and a second connection pipe are branched, the first connection pipe being connected such that water is supplied to the first electrochemical filter, the second connection pipe being connected from the first connection pipe to the second electrochemical filter; a first shut-off valve connected between the first connection pipe and a drain pipe; a second shut-off valve connected between the second connection pipe and the drain pipe; and a third shut-off valve and a fourth shut-off valve provided at a first outflow pipe connected to the first electrochemical filter and a second outflow pipe connected to the second electrochemical filter, respectively.

When the first electrochemical filter performs the recycling operation, the control unit may switch a flow passage of the flow passage switch valve such that water may be supplied to the second connection pipe.

The control unit may open the first shut-off valve and close the second shut-off valve, such that waste water generated during the recycling of the first electrochemical filter may be discharged to the exterior through the drain pipe. The control unit may open the second shut-off valve and close the first shut-off valve, such that water generated during the recycling of the second electrochemical filter may be discharged to the exterior through the drain pipe.

The control unit may close the third shut-off valve when the recycling of the first electrochemical filter has been completed. The control unit may close the fourth shut-off valve when the recycling of the second electrochemical filter has been completed.

The water treatment apparatus may further include check valves provided in the first connection pipe and the second connection pipe, such that waste water generated during the recycling of the first and second electrochemical filters is prevented from flowing back into the first connection pipe and the second connection pipe.

The filter unit may further include a pre-carbon filter at a front end of the first and second electrochemical filters, and water filtered by the pre-carbon filter may be supplied to the first and second electrochemical filters.

The filter unit may further include a post-carbon filter at a rear end of the first and second electrochemical filters.

The water treatment apparatus may further include a flow rate sensor installed on a water flow path at a rear end of the first and second electrochemical filters.

The water treatment apparatus may further include a first electrical conductivity sensor installed on a flow passage in a front end of the first and second electrochemical filters, and the control unit may control magnitudes of voltages applied to the first and second electrochemical filters, depending on a value measured by the first electrical conductivity sensor.

The water treatment apparatus may further include a second electrical conductivity sensor installed on a water flow passage at a rear end of the first and second electrochemical filters, and the control unit may control magnitudes of voltages applied to the first and second electrochemical filters, depending on a value measured by the second electrical conductivity sensor.

The first and second electrochemical filters may be implemented with capacitive deionization (CDI) cells.

According to another aspect of the present invention, there is provided a water treatment method for purifying raw water through a filter unit, including a first electrochemical filter and a second electrochemical filter installed in parallel, the water treatment method including: supplying raw water to at least one of the first electrochemical filter and the second electrochemical filter; determining whether the first electrochemical filter needs to be recycled; when the first electrochemical filter needs to be recycled, controlling the first electrochemical filter to perform a recycling operation, and controlling the second electrochemical filter to perform a water purifying operation; and when the first electrochemical filter does not need to be recycled, controlling the first electrochemical filter to perform a water purifying operation.

The water treatment method may further include: when the recycling of the first electrochemical filter has been completed, determining whether the second electrochemical filter needs to be recycled; when the second electrochemical filter needs to be recycled, controlling the second electrochemical filter to perform a recycling operation, and controlling the first electrochemical filter to perform the water purifying operation; and when the second electrochemical filter does not need to be recycled, controlling the first electrochemical filter to be in an idle state, and controlling the second electrochemical filter to continue to perform the water purifying operation.

The water treatment method may further include: when the first electrochemical filter is in the process of being recycled, determining whether the recycling of the first electrochemical filter has been completed; when the recycling of the first electrochemical filter has been completed, controlling the first electrochemical filter to perform the water purifying operation, and controlling the second electrochemical filter to perform the recycling operation; and when the recycling of the first electrochemical filter is not completed, controlling the first electrochemical filter to continue to perform the recycling operation, and controlling the second electrochemical filter to continue to perform the water purifying operation.

A flow rate sensor may be further installed in a water flow passage at a rear end of the first and second electrochemical filters, and the necessity of recycling the first and second electrochemical filters may be determined, based on data detected by the flow rate sensor.

A first electrical conductivity sensor may be further installed at a front end of the filter unit, and a second electrical conductivity sensor may be further installed at a rear end of the filter unit. The necessity of recycling the first and second electrochemical filters may be determined, based on a difference between total dissolved solid (TDS) values detected by the first and second electrochemical filters.

The necessity of recycling the first and second electrochemical filters may be determined by allowable purification time of the first and second electrochemical filters.

The necessity of recycling the first and second electrochemical filters may be determined by current values of purified waters filtered by the first and second electrochemical filters.

### Advantageous Effects of Invention

According to exemplary embodiments of the present invention, a plurality of electrochemical filters are installed in parallel. While one of the electrochemical filters performs a recycling operation, another may perform a water purifying operation. Therefore, a recycling operation of an electrochemical filter may be easily performed, without stopping a water purifying operation of a water purifier. As a result, a water purifying operation may be continuously performed.

Furthermore, one electrochemical filter may only be operated when another performs a recycling operation. Therefore, an entire water purifier may be manufactured to have a small size.

### BRIEF DESCRIPTION OF DRAWINGS

The above and other aspects, features and other advantages of the present invention will be more clearly understood from the following detailed description taken in conjunction with the accompanying drawings, in which:

FIG. 1 is a view explaining a CDI process;

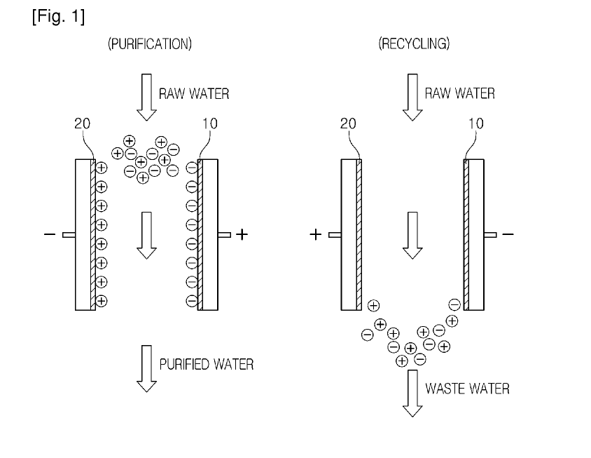

FIG. 2 is a block diagram of a water treatment apparatus according to an exemplary embodiment of the present invention;

FIG. 3 is a block diagram explaining a water purifying operation of a first electrochemical filter in the water treatment apparatus of FIG. 2;

FIG. 4 is a block diagram explaining a recycling operation of the first electrochemical filter in the water treatment apparatus of FIG. 2;

FIG. 5 is a block diagram of a water treatment apparatus according to another exemplary embodiment of the present invention;

FIG. 6 is a flow diagram schematically illustrating an operation state during a water purifying operation of a first electrochemical filter in the water treatment apparatus of FIG. 5;

FIG. 7 is a flow diagram schematically illustrating an operation state during a recycling operation of the first electrochemical filter in the water treatment apparatus of FIG. 5;

FIG. 8 is a flow diagram illustrating a water treatment method according to an exemplary embodiment of the present invention; and

FIG. 9 is a flow diagram illustrating a water treatment method according to another exemplary embodiment of the present invention.

### BEST MODE FOR CARRYING OUT THE INVENTION

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals in the drawings denote like elements, and thus their description will be omitted.

The terms used in this specification are used for describing specific embodiments and do not limit the scope of the present invention. A singular expression may include a plural expression, as long as they are obviously different from each other in context.

In this application, the meanings of terms such as ‘include’ or ‘have’ specify a property, a fixed number, a step, a process, an element, a component, and/or a combination thereof but do not exclude other properties, fixed numbers, steps, processes, elements, components, and/or combinations thereof.

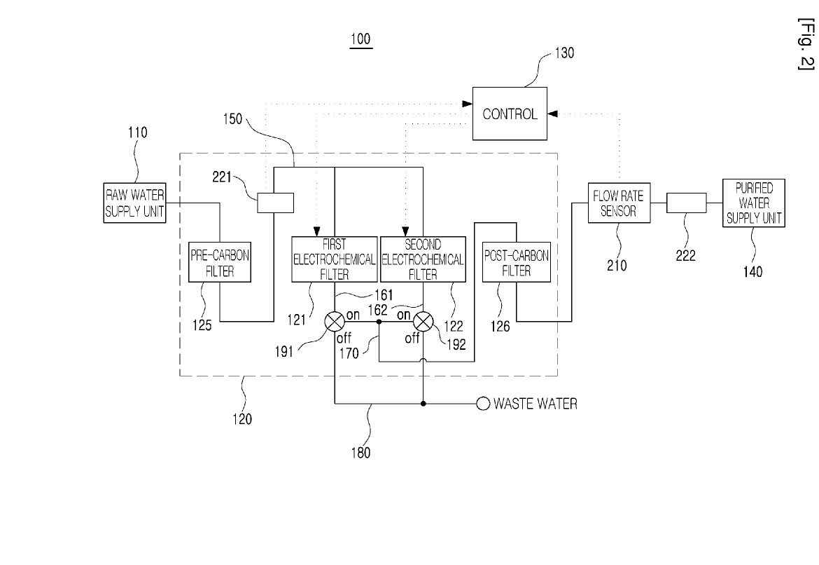

First, a water treatment apparatus according to an exemplary embodiment of the present invention will be described with reference to FIG. 2. FIG. 2 is a block diagram schematically illustrating a water treatment apparatus according to an exemplary embodiment of the present invention.

Referring to FIG. 2, a water treatment apparatus 100 according to an exemplary embodiment of the present invention may include a raw water supply unit 110, a filter unit 120, a control unit 130, and a purified water supply unit 140.

The raw water supply unit 110 may supply the water treatment apparatus 100 with untreated raw water, such as tap water or underground water.

The filter unit 120 may generate purified water by filtering the raw water supplied from the raw water supply unit 110. The filter unit 120 may be provided with a plurality of filters. According to an exemplary embodiment, the filter unit 120 may include a first electrochemical filter 121 and a second electrochemical filter 122, which are installed in parallel.

The electrochemical filter can adsorb, remove or separate ionic materials by electricity. The electrochemical filter may be a CDI cell; however, the present invention is not limited thereto.

The CDI cell as an example of the electrochemical filter has a stack structure of a positive electrode and a negative electrode, and a spacer is disposed between the positive electrode and the negative electrode. Due to the spacer, the positive electrode and the negative electrode are spaced apart from each other to form a water flow passage therebetween.

In this case, the spacer may be a mesh fabric or a nonwoven fabric, which can absorb water and be woven densely.

In addition, the positive and negative electrodes of each cell may be made of a material having high conductivity. The positive and negative electrodes may be made of a material selected from graphite, carbon paper fiber, a metal mesh such as titanium, and a mixture thereof.

Since a low voltage is applied to the positive and negative electrodes, the positive and negative electrodes may be made of a material that has high conductivity and is not corrosive.

An operational principle of the electrochemical filter will be described below. If a positive voltage is applied to the positive electrode and a negative voltage is applied to the negative electrode, anions contained in water flowing through the spacer are adsorbed on the positive electrode.

On the other hand, if a negative voltage is applied to the negative electrode, cations contained in water flowing through the spacer are adsorbed.

Therefore, water flowing through the spacer between the electrodes is purified into water close to pure water in which ions do not remain, that is, water having a total dissolved solid (TDS) level of almost zero.

Such an electrochemical filter needs to perform a recycling operation at regular intervals to remove impurities adsorbed on the electrodes during the water purifying operation thereof.

After performing the water purifying operation for allowable water purification time, the electrochemical filter may be recycled by the recycling operation to purify raw water again.

The allowable water purification time and the recycling time of the electrochemical filter are preset, depending on the configuration of the electrochemical filter.

In addition, the water purification time and the recycling time of the electrochemical filter may be equal to each other or different from each other.

Furthermore, the allowable electrochemical filter water purification time may be in proportion to the capacity of the electrochemical filter, and the capacity of the electrochemical filter may be in proportion to the size of the electrode included in the electrochemical filter.

As a result, as the electrochemical filter water purification time increases, the volume of the electrochemical filter may also increase.

Meanwhile, the filter unit 120 of the water treatment apparatus 100 according to the exemplary embodiment of the present invention may further include a pre-carbon filter 125 at a front end of the first and second electrochemical filters 121 and 122, and a post-carbon filter 126 at a rear end of the first and second electrochemical filters 121 and 122. However, the present invention is not limited thereto. A type, number, and order of filters may be changed, depending on a filtering method of the water purifier or a required filtering performance of the water purifier.

For example, a sediment filter may be provided at a front end of the pre-carbon filter 125.

The pre-carbon filter 125 may be configured to filter out and remove floating materials (particles), such as dust particles, sand grains, or oxidized pollutants, which are contained in raw water, such as public water or ground water introduced from the raw water supply unit 110, and may adsorb and remove residual chlorine (for example, HOCl— or ClO—) and volatile organic compounds.

The pre-carbon filter 125 may be configured in a hybrid filter form. For example, the pre-carbon filter 125 may be integrally formed with a sediment filter.

In addition, the post-carbon filter 126 may adsorb and remove additional chlorine components, volatile organic chemicals, and odors from purified water passing through the first and second electrochemical filters 121 and 122, and may improve the taste of water. According to an exemplary embodiment, the post-carbon filter 126 may be made of a material, such as activated carbon composed of carbon as a main component.

Meanwhile, the control unit 130 may be connected to the first electrochemical filter 121, the second electrochemical filter 122, a flow rate sensor 210, an electrical conductivity sensor, a flow passage switch valve 300, and a shut-off valve, to drive and control the respective elements.

Meanwhile, the purified water supply unit 140 is configured to supply a user with purified water filtered by the filter unit 120. The purified water supply unit 140 may be configured with a faucet or cock.

In the water treatment apparatus 100 having the above-described configuration, according to the exemplary embodiment of the present invention, the control unit 130 may control the second electrochemical filter 122 to perform a water purifying operation when the first electrochemical filter 121 needs to be recycled.

That is, when the first electrochemical filter 121 needs to be recycled in the process of purifying water, the second electrochemical filter 122 may perform the water purifying operation. While the second electrochemical filter 122 performs the water purifying operation, the first electrochemical filter 121 may perform the recycling operation.

On the other hand, the control unit 130 may control the first electrochemical filter 121 to perform the water purifying operation when the second electrochemical filter 121 needs to be recycled.

That is, when the second electrochemical filter 122 needs to be recycled in the process of purifying water, the first electrochemical filter 121 may perform the water purifying operation. While the first electrochemical filter 121 performs the water purifying operation, the second electrochemical filter 122 may perform the recycling operation.

In addition, as described above, the first electrochemical filter 121 and the second electrochemical filter 122 may repetitively perform the recycling operation and the water purifying operation.

In this manner, the water treatment apparatus 100 according to the exemplary embodiment of the present invention may supply a user with purified water, without stopping the water purifying operation.

The first electrochemical filter 121 and the second electrochemical filter 122 may have the same capacity.

In addition, the water purification time and the recycling time of the first and second electrochemical filters 121 and 122 may be equal to each other.

Meanwhile, according to another exemplary embodiment, the control unit 130 may control the second electrochemical filter 122 to perform the water purifying operation when the first electrochemical filter 121 performs the recycling operation. In this case, when the recycling of the first electrochemical filter 121 has been completed, the control unit 130 may perform a filter switching operation such that the first electrochemical filter 121 performs the water purifying operation.

In other words, the first electrochemical filter 121 may be used as a main filter, and the second electrochemical filter 122 may be used as an auxiliary filter to perform the water purifying operation only when the first electrochemical filter 121 performs the recycling operation.

In general, the recycling time of the electrochemical filter is shorter than the allowable water purification time thereof. Therefore, in a case in which the first electrochemical filter 121 is used as a main filter and the second electrochemical filter 122 is used as an auxiliary filter, the capacity of the second electrochemical filter 122 may be configured to be lower than that of the first electrochemical filter 121.

Therefore, the allowable purification time and the recycling time of the second electrochemical filter 122 may be configured to be shorter than those of the first electrochemical filter 121.

In addition, in this case, the volume of the second electrochemical filter 122 may be reduced, leading to a decrease in the entire volume of the water treatment apparatus 100.

However, the present invention is not limited thereto. For example, the capacity of the first electrochemical filter 121 may be configured to be equal to that of the second electrochemical filter 122.

Meanwhile, the water treatment apparatuses 100 according to the exemplary embodiments of the present invention may be configured such that the recycling of the second electrochemical filter 122 has been completed within the water purification time of the first electrochemical filter 121, so as to avoid a situation that the first and second electrochemical filters 121 and 122 need to be recycled at the same time, and thus, both the first and second electrochemical filters 121 and 122 do not perform the water purifying operation.

To this end, the water treatment apparatus 100 according to the exemplary embodiment of the present invention may include a treated water supply pipe 150, a first outflow pipe 161, a second outflow pipe 162, a purified water pipe 170, and a drain pipe 180.

The treated water supply pipe 150 may be provided to connect the pre-carbon filter 125 to the first and second electrochemical filters 121 and 122. The treated water supply pipe 150 may circulate the treated water filtered by the pre-carbon filter 125 to the first electrochemical filter 121 and the second electrochemical filter 122.

The first electrochemical filter 121 and the second electrochemical filter 122 may adsorb and remove heavy metals and ionic materials contained in the treated water filtered by the pre-carbon filter 125.

In addition, the first outflow pipe 161 may be connected to a rear end of the first electrochemical filter 121 to discharge water having passed through the first electrochemical filter 121.

In addition, the second outflow pipe 162 may be connected to a rear end of the second electrochemical filter 122 to discharge water having passed through the second electrochemical filter 122.

Furthermore, the purified water pipe 170 may be connected to the first outflow pipe 161 and the second outflow pipe 162, such that water filtered by the first electrochemical filter 121 and the second electrochemical filter 122 flows therethrough. The purified water pipe 170 may be connected to the post-carbon filter 126, such that water filtered by the first electrochemical filter 121 and the second electrochemical filter 122 is filtered by the post-carbon filter 126.

Moreover, the drain pipe 180 may be connected to the first outflow pipe 161 and the second outflow pipe 162. The drain pipe 180 may drain waste water, generated during the recycling operation of the first electrochemical filter 121 or the second electrochemical filter 122, to the exterior of the water treatment apparatus 100.

Meanwhile, the water treatment apparatus 100 according to the exemplary embodiment of the present invention may further include a first flow passage switch valve 191 and a second flow passage switch valve 192 to switch a water flow passage.

The first flow passage switch valve 191 may be provided at a branch point to which the first outflow pipe 161, the purified water pipe 170, and the drain pipe 180 are connected. The first flow passage switch valve 191 may selectively connect the first outflow pipe 161 to the purified water pipe 170 or the drain pipe 180. That is, the first flow passage switch valve 191 may switch the water flow passage to allow water having passed through the first electrochemical filter 121 to flow through the purified water pipe 170 or the drain pipe 180.

The second flow passage switch valve 192 may be provided at a branch point to which the second outflow pipe 162, the purified water pipe 170, and the drain pipe 180 are connected. The second flow passage switch valve 192 may selectively connect the second outflow pipe 162 to the purified water pipe 170 or the drain pipe 180. That is, the second flow passage switch valve 192 may switch the water flow passage to allow water having passed through the second electrochemical filter 122 to flow through the purified water pipe 170 or the drain pipe 180.

Meanwhile, the water treatment apparatus 100 according to the exemplary embodiment of the present invention may further include a flow rate sensor 210, a first electrical conductivity sensor 221, and a second electrical conductivity sensor 222.

The flow rate sensor 210 may be installed on a water flow passage in a rear end of the first and second electrochemical filters 121 and 122. According to an exemplary embodiment, the flow rate sensor 210 may be provided at a rear stage through which treated water from the post-carbon filter 126 is discharged. The flow rate sensor 210 may be configured to detect a cumulative amount of discharged water passing through the filter unit 120 after raw water is introduced thereto.

The control unit 130 may be configured to add the cumulative discharge amount of water, measured by the flow rate sensor 210, and control the filter recycling operation when the value is equal to or greater than a predetermined amount.

In addition, the first electrical conductivity sensor 221 may be installed on a water flow passage in a front end of the first and second electrochemical filters 121 and 122. According to an exemplary embodiment, the first electrical conductivity sensor 221 may be provided at a front stage through which treated water from the pre-carbon filter 125 is introduced.

In addition, the second electrical conductivity sensor 222 may be installed on a water flow passage in the rear end of the first and second electrochemical filters 121 and 122. According to an exemplary embodiment, the second electrical conductivity sensor 222 may be provided at a rear stage through which treated water from the post-carbon filter 126 is discharged.

In the water treatment apparatus 100 having the above configuration, according to the exemplary embodiment of the present invention, the control unit 130 may control magnitudes of voltages applied to the first electrochemical filter 121 and the second electrochemical filter 122, depending on values measured by the first electrical conductivity sensor 221 and the second electrical conductivity sensor 222.

That is, the control unit 130 may compare the electrical conductivity measured by the first electrical conductivity sensor 221 with the electrical conductivity measured by the second electrical conductivity sensor 222, and measure a variation in electrical conductivity. Then, the control unit 130 may measure an error using the variation in electrical conductivity, and select a desired taste of water.

The taste of water may be changed by adjusting the magnitudes of the voltages applied to the first electrochemical filter 121 and the second electrochemical filter 122.

In addition, if a difference between the electrical conductivity measured by the first electrical conductivity sensor 221 and the electrical conductivity measured by the second electrical conductivity sensor 222 is known, a variation in recycling abilities of the first electrochemical filter 121 and the second electrochemical filter 122 may be known.

Therefore, the point in time for the recycling of the first and second electrochemical filters 121 and 122 may be determined based on the difference of the electrical conductivity, and may control the water purifying operation and the recycling operation of the first and second electrochemical filters 121 and 122.

For reference, the electrical conductivity of the treated water is used for measuring a TDS. The electrical conductivity is measured using a principle that a TDS value is changed by an amount of electricity flowing through two sensors disposed at an end of measuring equipment.

That is, if a large amount of ionic materials exists in the water, electricity easily flows and a large TDS value is shown. TDS is a scale that represents how many materials other than oxygen are contained in the water. The taste of water is determined by materials contained in the water.

Therefore, the water treatment apparatus 100 according to the exemplary embodiment of the present invention may measure the variation in the electrical conductivity of the treated water using the electrical conductivity sensor, and select the taste of water by controlling the performance of the filter unit 120, based on the measurement result.

In addition, in the water treatment apparatus 100 according to the exemplary embodiment of the present invention, the point in time for the recycling of the first and second electrochemical filters 121 and 122 may be determined based on a current flowing through purified water filtered by the first and second electrochemical filters 121 and 122. That is, since an amount of ions contained in the purified water is in proportion to a current value, the point in time for the recycling of the electrochemical filter may be determined using the current value.

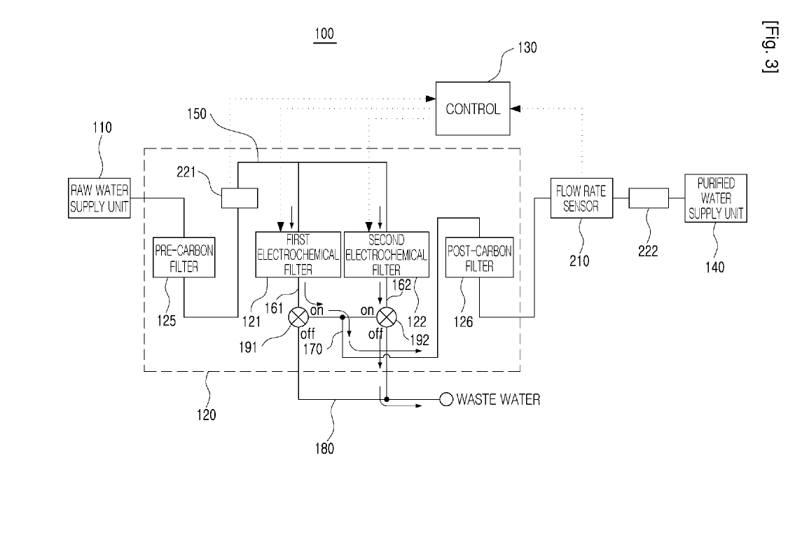

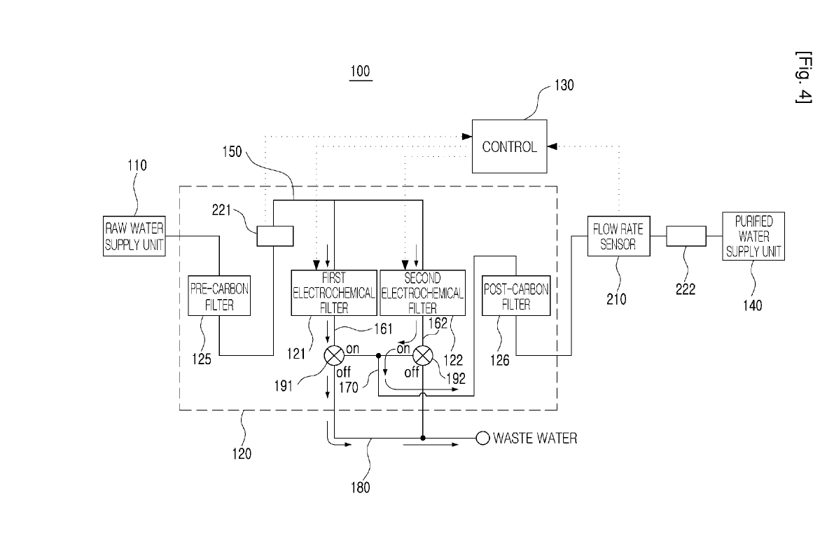

Next, a water treating operation of the water treatment apparatus, according to an exemplary embodiment of the present invention, will be described with reference to FIGS. 3 and 4. FIG. 3 is a block diagram explaining the water purifying operation of the first electrochemical filter included in the water treatment apparatus according to the exemplary embodiment of the present invention. FIG. 4 is a block diagram explaining the recycling operation of the first electrochemical filter.

First, referring to FIG. 3, in a case in which the first electrochemical filter 121 performs the water purifying operation and the second electrochemical filter 122 performs the recycling operation, the control unit 130 switches on the first flow passage switch valve 191 to supply purified water from the first outflow pipe 161 to the purified water pipe 170, and switches off the second flow passage switch valve 192 to discharge waste water from the second outflow pipe 162 to the drain pipe 180.

In this case, the control unit 130 may apply a water purifying voltage to the first electrochemical filter 121 and apply a recycling voltage to the second electrochemical filter 122. Polarities of the water purifying voltage and the recycling voltage are opposite to each other.

Meanwhile, as illustrated in FIG. 4, in a case in which the second electrochemical filter 122 performs the water purifying operation and the first electrochemical filter 121 performs the recycling operation, the control unit 130 switches on the second flow passage switch valve 192 to supply purified water from the second outflow pipe 162 to the purified water pipe 170, and switches off the first flow passage switch valve 191 to discharge waste water from the first outflow pipe 161 to the drain pipe 180.

In this case, the control unit 130 may apply a recycling voltage to the first electrochemical filter 121 and apply a water purifying voltage to the second electrochemical filter 122.

Meanwhile, in an exemplary embodiment, in a case in which the recycling time of the first and second electrochemical filters 121 and 122 is shorter than the allowable water purification time thereof, if water is continuously supplied to the recycled electrochemical filter, the supplied water is discharged to the drain pipe 180.

In order to solve this problem, shut-off valves (not shown) may be provided in water flow passages through which water flows into the first electrochemical filter 121 and the second electrochemical filter 122.

The control unit 130 may prevent water from flowing into the recycled electrochemical filter by closing the shut-off valve disposed at the recycled electrochemical filter side.

Meanwhile, in such a configuration, when switching the water purifying operation and the recycling operation between the first electrochemical filter 121 and the second electrochemical filter 122, waste water may remain in the outflow pipes 161 and 162 connected to the electrochemical filters switching from the recycling operation to the water purifying operation. At this time, if the electrochemical filter switching to the water purifying operation generates purified water and discharges the purified water through the purified water pipe 170, waste water may be mixed in the initially discharged purified water.

In order to solve this problem, the control unit 130 may perform a control operation such that the electrochemical filter continues to perform the water purifying operation for a preset period of time, and the flow passage switch valve 300 provided at a branch point of the outflow pipes 161 and 162 connected to the electrochemical filter being recycled is switched to the purified water pipe 170 after a preset period of time has elapsed.

For example, while the first electrochemical filter 121 is being recycled and the second electrochemical filter 122 is purifying water, if the water purifying operation and the recycling operation are mutually switched, the first electrochemical filter 121 may perform the water purifying operation, and the second electrochemical filter 122 may stop the water purifying operation and perform the recycling operation.

In this case, if the first electrochemical filter 121 performs the water purifying operation when waste water generated during the recycling operation of the first electrochemical filter 121 remains in the first outflow pipe 161, the waste water remaining in the first outflow pipe 161 may be discharged through the purified water pipe 170.

Therefore, the control unit 130 may control the second electrochemical filter 122 to continuously perform the water purifying operation, maintain the first flow passage switch valve 191 in an off state, and maintain the second flow passage switch valve 192 in an on state.

In this manner, the waste water remaining in the first outflow pipe 161 may be discharged through the drain pipe 180, and the second electrochemical filter 122 may perform the water purifying operation during the discharging of the waste water.

For the preset period of time, the control unit 130 may switch the recycling voltage of the first electrochemical filter 121 to the water purifying voltage, and may maintain the water purifying voltage of the second electrochemical filter 122.

The preset period of time may be set as a period of time necessary for waste water remaining in the first outflow pipe 161 to be filtered by the first electrochemical filter 121 and discharged with the initially discharged water.

Meanwhile, the electrochemical filter may be effectively recycled when purified water is used for recycling.

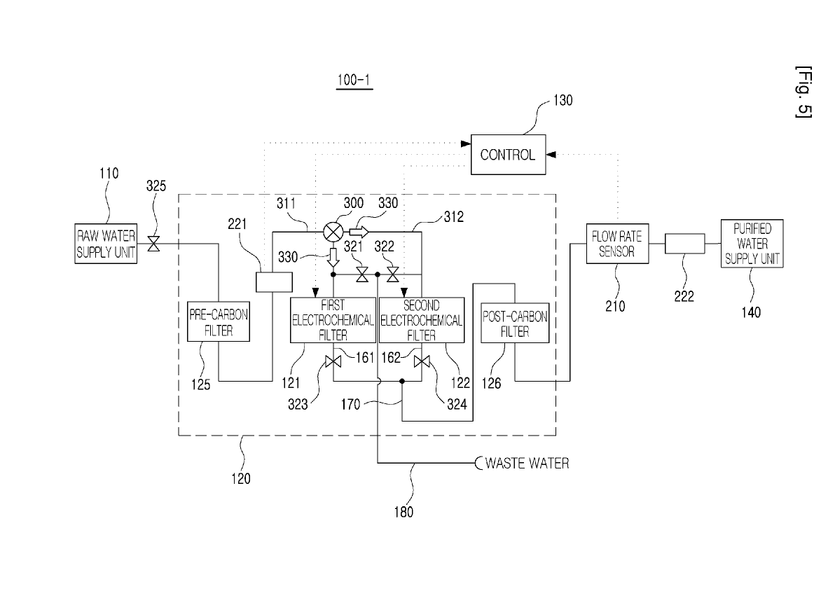

To this end, the water treatment apparatus according to another exemplary embodiment of the present invention may be configured as illustrated in FIG. 5. FIG. 5 is a block diagram of a water treatment apparatus according to another exemplary embodiment of the present invention.

Referring to FIG. 5, in a water treatment apparatus 100-1 according to another exemplary embodiment of the present invention, when a first electrochemical filter 121 performs a recycling operation, a control unit 130 may supply an amount of purified water filtered by a second electrochemical filter 122 to the first electrochemical filter 121 for recycling the first electrochemical filter 121.

That is, an amount of purified water generated by the second electrochemical filter 122 may be supplied to the first electrochemical filter 121 through a first outflow pipe 161, and the rest of the purified water may be supplied to a purified water supply unit 140 through a purified water pipe 170.

To this end, the water treatment apparatus 100-1 according to another exemplary embodiment of the present invention may further include a first connection pipe 311, a second connection pipe 312, a flow passage switch valve 300, a first shut-off valve 321, a second shut-off valve 322, a third shut-off valve 323, a fourth shut-off valve 324, and check valves 330.

The first connection pipe 311 may be connected such that treated water filtered by the pre-carbon filter 125 is supplied to the first electrochemical filter 121.

In addition, the second connection pipe 312 may be connected from the first connection pipe 311 to the second electrochemical filter 122.

In this case, the first connection pipe 311 and the second connection pipe 312 may replace the treated water supply pipe 150 included in the water treatment apparatus 100 illustrated in FIGS. 2 through 4.

In addition, the flow passage switch valve 300 may be provided at a position from which the first connection pipe 311 and the second connection pipe 312 are branched. The flow passage switch valve 300 may switch from the first connection pipe 311 to the second connection pipe 312, such that the flow of the treated water is selectively changed from the first connection pipe 311 to the second connection pipe 312.

In addition, the first shut-off valve 321 may be connected between the first connection pipe 311 and a drain pipe 180, and the second shut-off valve 322 may be connected between the second connection pipe 312 and the drain pipe 180.

The first shut-off valve 321 and the second shut-off valve 322 may prevent treated water introduced from a pre-carbon filter 125 from flowing through a drain pipe 180.

In addition, the third shut-off valve 323 may be provided at the first outflow pipe 161 connected to the first electrochemical filter 121. The third shut-off valve 323 may shut off the flow of water discharged from the first electrochemical filter 121.

Furthermore, the fourth shut-off valve 324 may be provided at the second outflow pipe 162 connected to the second electrochemical filter 122. The fourth shut-off valve 324 may shut off the flow of water discharged from the second electrochemical filter 122.

However, in an exemplary embodiment, the third shut-off valve 323 may not be provided because the third shut-off valve 323 is opened during both the recycling operation and the water purifying operation of the first electrochemical filter 121.

In addition, the check valves 330 are provided at the first connection pipe 311 and the second connection pipe 312. The check valves 330 may prevent waste water from flowing back into the first connection pipe 311 and the second connection pipe 312 when the first and second electrochemical filters 121 and 122 perform the recycling operation.

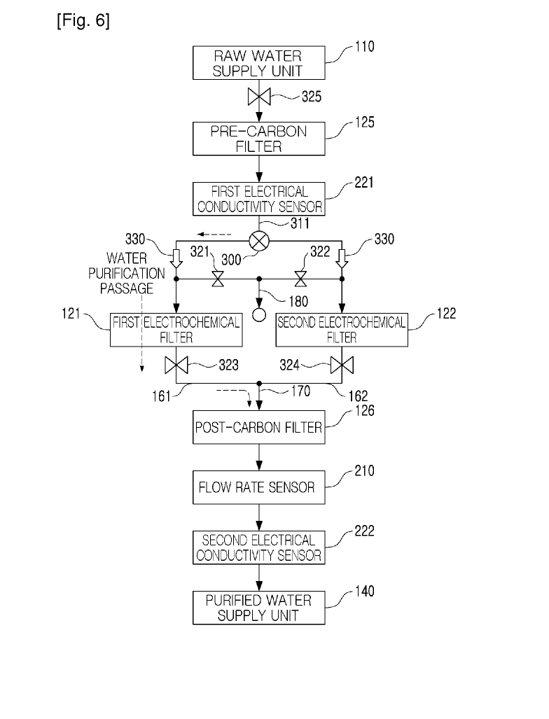

Meanwhile, FIG. 6 is a flow diagram schematically illustrating the operation state during the water purifying operation of the first electrochemical filter 121 in the water treatment apparatus 100-1 illustrated in FIG. 5.

Referring to FIG. 6, if a raw water shut-off valve 325 configured to shut off a raw water supply of the raw water supply unit 110 is opened, raw water is introduced from a raw water supply source to the pre-carbon filter 125.

The pre-carbon filter 125 may filter out particles from the introduced raw water, and adsorb and remove chlorine and volatile organic compounds.

At this time, a first electrical conductivity sensor 221 provided between the pre-carbon filter 125 and the first connection pipe 311 may measure an electrical conductivity of treated water filtered by the pre-carbon filter 125.

The flow passage switch valve 300 provided at the first connection pipe 311 is switched such that treated water flows in a direction from the pre-carbon filter 125 to the first electrochemical filter 121. Accordingly, treated water from the pre-carbon filter 125 does not flow into the second electrochemical filter 122.

A backflow of treated water is prevented by the backflow prevention check valve 330 provided at the first connection pipe 311. The first shut-off valve disposed between the first electrochemical filter 121 and the drain pipe 180 is closed to prevent the introduced treated water from being discharged to the drain pipe 180.

That is, the treated water from the pre-carbon filter 125 flows into the first electrochemical filter 121, and the first electrochemical filter 121 performs a water purifying operation to adsorb and remove heavy metals and ionic materials contained in the treated water.

In this case, the third shut-off valve 323 provided at the first electrochemical filter 121 and the first outflow pipe 161 is opened, and the fourth shut-off valve 324 provided between the second electrochemical filter 122 and the second outflow pipe 162 is closed.

Accordingly, water purified by the first electrochemical filter 121 does not flow into the second electrochemical filter 122, and flows into only the post-carbon filter 126 through the purified water pipe 170.

As a result, the water purification passage of the first electrochemical filter 121 may be formed as follows: the pre-carbon filter 125→the first connection pipe 311→the first electrochemical filter 121→the first outflow pipe 161→the post-carbon filter 126.

Then, the post-carbon filter 126 may additionally adsorb and remove residual chlorine and volatile organic chemicals from the purified water filtered by the first electrochemical filter 121. The purified water filtered by the post-carbon filter 126 may be supplied to a user through the purified water supply unit 140.

At this time, the flow rate sensor 210 may measure a discharge amount of purified water supplied from the post-carbon filter 126 to the purified water supply unit 140, and a second electrical conductivity sensor 222 may measure an electrical conductivity of the purified water.

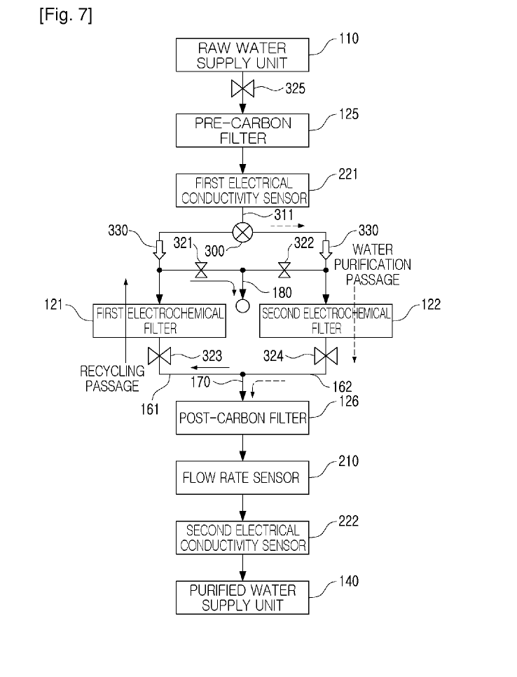

Meanwhile, FIG. 7 is a flow diagram schematically illustrating the operation state during the recycling operation of the first electrochemical filter 121 in the water treatment apparatus 100-1 illustrated in FIG. 5.

In the case of the recycling of the first electrochemical filter 121, the flow passage switch valve 300 is switched such that treated water from the pre-carbon filter 125 flows toward the second electrochemical filter 122. Accordingly, the treated water from the pre-carbon filter 125 does not flow into the first electrochemical filter 121.

Specifically, as illustrated in FIG. 7, purified water filtered by the second electrochemical filter 122 may flow into the first electrochemical filter 121 and be used as a flushing water during the recycling operation of the first electrochemical filter 121.

That is, a direction in which water flows through the first electrochemical filter 121 is opposite to a direction in which water is filtered in the first electrochemical filter 121.

Waste water generated during the recycling operation of the first electrochemical filter 121 is discharged to the exterior through the drain pipe 180.

At this time, the backflow prevention check valve provided at the first connection pipe 311 prevents a backflow of the waste water. The second shut-off valve 322, provided at the second connection pipe 312, is closed to prevent the waste water from flowing into the second electrochemical filter 122 and to prevent the treated water filtered by the pre-carbon filter 125 from flowing into the drain pipe 180.

Therefore, the recycling passage of the first electrochemical filter 121 may be formed as follows: the first outflow pipe 161→the first electrochemical filter 121→the first connection pipe 311→the drain pipe 180.

During the recycling operation of the first electrochemical filter 121, the second electrochemical filter 122 performs the water purifying operation. Since the water purifying operation of the second electrochemical filter 122 is substantially identical to the water purifying operation of the first electrochemical filter 121 described above with reference to FIG. 5, detailed descriptions thereof will be omitted.

A difference is that both the third shut-off valve 323 and the fourth shut-off valve 324 are opened.

Accordingly, purified water filtered by the second electrochemical filter 122 may flow into the first electrochemical filter 121 and be used as a flushing water for electrode flushing of the first electrochemical filter 121. The purified water may also flow into the post-carbon filter 126.

Therefore, the water purification passage of the second electrochemical filter 122 may be formed as follows: the pre-carbon filter 125→the second connection pipe 312→the second electrochemical filter 122→the second outflow pipe 162→the post-carbon filter 126.

Thereafter, when the recycling of the first electrochemical filter 121 has been completed, the flow passage switch valve 300 may be switched again such that the treated water from the post-carbon filter 126 flows toward the first electrochemical filter 121, and the opened first and fourth shut-off valves 321 and 324 may be closed.

In this manner, the first electrochemical filter 121 may perform the water purifying operation again, and the second electrochemical filter 122 may stop the water purifying operation.

Meanwhile, the recycling of the second electrochemical filter 122 may be performed during the water purifying operation of the first electrochemical filter 121 illustrated in FIG. 6. In this case, the second shut-off valve 322 and the fourth shut-off valve may be opened.

The second electrochemical filter 122 may perform the recycling operation using the purified water introduced from the first electrochemical filter 121, and waste water generated during the recycling operation may be discharged to the exterior through the drain pipe 180.

Meanwhile, in another exemplary embodiment illustrated in FIGS. 5 through 7, when switching the water purifying operation and the recycling operation of the first electrochemical filter 121 and the second electrochemical filter 122, waste water generated during the recycling operation of the electrochemical filter may remain in the first connection pipe 311 and the second connection pipe 312. During the water purifying operation of the electrochemical filter, the flow of water is reversed. Thus, waste water remaining in the first connection pipe 311 and the second connection pipe 312 may pass through the electrochemical filter that starts purifying the treated water filtered by the pre-carbon filter 125.

Therefore, as in the case of the water treatment apparatus 100 illustrated in FIGS. 2 through 4, it may be unnecessary to overlap the water purification/recycling switch time of the first electrochemical filter 121 and the second electrochemical filter 122.

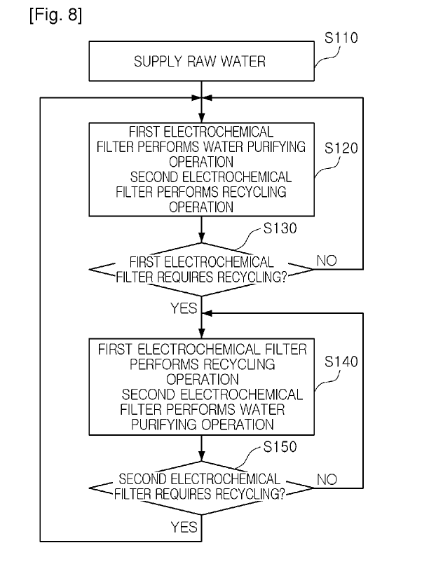

Next, a water treatment method according to an exemplary embodiment of the present invention will be described with reference to FIG. 8. FIG. 8 is a flow diagram illustrating a water treatment method according to an exemplary embodiment of the present invention.

In the water treatment method according to the exemplary embodiment of the present invention, raw water to be purified may be supplied to at least one of the first electro-chemical filter 121 and the second electrochemical filter 122 (S 110).

The supplied raw water may be purified by the first electrochemical filter 121 and, at this time, the second electrochemical filter 122 may be recycled (S 120).

It is repetitively determined whether the first electrochemical filter 121 needs to be recycled, while the first electrochemical filter 121 performs the water purifying operation (S 130). A time interval for determining whether the first electrochemical filter 121 needs to be recycled may be preset.

When it is determined that the first electrochemical filter 121 needs to be recycled, the first electrochemical filter 121 performs the recycling operation, and the second electrochemical filter 122 performs the water purifying operation (S 140).

On the other hand, when it is determined that the first electrochemical filter 121 does not need to be recycled, the first electrochemical filter 121 continues to perform the water purifying operation (S 120).

Meanwhile, it is repetitively determined whether the second electrochemical filter 122 needs to be recycled, while the first electrochemical filter 121 performs the recycling operation and the second electrochemical filter 122 performs the water purifying operation (S 150).

When it is determined that the second electrochemical filter 122 needs to be recycled, the second electrochemical filter 122 performs the recycling operation and the first electrochemical filter 121 performs the water purifying operation (S 120).

That is, the process is repeated from operation S120 in which the first electro-chemical filter 121 performs the water purifying operation and the second electro-chemical filter 122 performs the recycling operation.

On the other hand, when it is determined that the second electrochemical filter 122 does not need to be recycled, the second electrochemical filter 122 continues to perform the water purifying operation (S140).

In this manner, the water treatment method according to the exemplary embodiment of the present invention may continuously perform water purification because the first and second electrochemical filters 121 and 122 repeat the water purifying operation and the recycling operation.

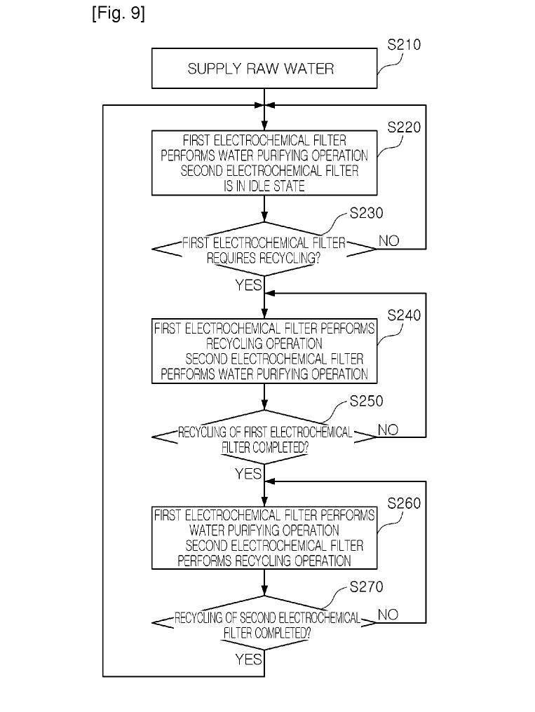

Next, a water treatment method according to another exemplary embodiment of the present invention will be described with reference to FIG. 9. FIG. 9 is a flow diagram illustrating a water treatment method according to another embodiment of the present invention.

In the water treatment method according to another exemplary embodiment of the present invention, raw water to be purified may be supplied to at least one of the first electrochemical filter 121 and the second electrochemical filter 122 (S210).

The supplied raw water may be purified by the first electrochemical filter 121 and, at this time, the second electrochemical filter 122 may be in an idle state (S220).

It is repetitively determined whether the first electrochemical filter 121 needs to be recycled, while the first electrochemical filter 121 performs the water purifying operation (S230).

When it is determined that the first electrochemical filter 121 needs to be recycled, the first electrochemical filter 121 performs the recycling operation and the second electrochemical filter 122 performs the water purifying operation (S240).

On the other hand, when it is determined that the first electrochemical filter 121 does not need to be recycled, the first electrochemical filter 121 continues to perform the water purifying operation (S220).

Meanwhile, while the first electrochemical filter 121 performs the recycling operation and the second electrochemical filter 122 performs the water purifying operation, it is determined whether the recycling of the first electrochemical filter 121 has been completed (S250).

At this time, the completion of the recycling of the first electrochemical filter 121 may be determined according to whether the recycling time of the electrochemical filter has elapsed. In this case, it may not be repetitively determined whether the recycling of the electrochemical filter has been completed.

When it is determined that the recycling of the first electrochemical filter 121 has been completed, the second electrochemical filter 122 performs the recycling operation, and the first electrochemical filter 121 performs the water purifying operation (S260).

On the other hand, when it is determined that the recycling of the first electro-chemical filter 121 is not completed, the second electrochemical filter 122 continues to perform the water purifying operation, and the first electrochemical filter 121 continues to perform the recycling operation (S240).

Meanwhile, while the first electrochemical filter 121 performs the water purifying operation and the second electrochemical filter 122 performs the recycling operation, it is determined whether the recycling of the second electrochemical filter 122 has been completed (S270).

When it is determined that the recycling of the second electrochemical filter 122 has been completed, the first electrochemical filter 121 continues to perform the water purifying operation, and the second electrochemical filter 122 may be in an idle state (S220).

On the other hand, when it is determined that the recycling of the second electro-chemical filter 122 is not completed, the first electrochemical filter 121 continues to perform the water purifying operation, and the second electrochemical filter 122 continues to perform the recycling operation (S260).

In the water treatment method according to another exemplary embodiment of the present invention, the capacity of the first electrochemical filter 121 is larger than the capacity of the second electrochemical filter 122.

In this case, the first electrochemical filter 121 may be used as a main filter, and the second electrochemical filter 122 may be an auxiliary filter.

Meanwhile, the necessity of recycling the first electrochemical filter 121 and the second electrochemical filter 122 may be determined, based on data detected by the flow rate sensor 210. That is, a point in time at which the electrochemical filter needs to be recycled may be determined through a cumulative discharge amount of purified water that can be filtered by the electrochemical filter.

In addition, the necessity of recycling the first electrochemical filter 121 and the second electrochemical filter 122 may be determined, based on a difference of TDS values detected by the first electrical conductivity sensor 221 provided at the front end of the filter unit 120 and the second electrical conductivity sensor 222 provided at the rear end of the filter unit 120.

For example, if the difference of the TDS values of water before and after the filter unit 120 is reduced, it means that water is not effectively purified. Using this fact, the point in time at which the electrochemical filter performing the water purifying operation needs to be recycled may be determined.

In addition, the necessity of recycling the first electrochemical filter 121 and the second electrochemical filter 122 may be determined by the allowable purification time of the first and second electrochemical filters 121 and 122.

That is, in a case in which the water treatment apparatuses 100 and 100-1 extract the same amount of purified water per hour, a total time for which the electrochemical filter purifies water is measured. The point in time at which the electrochemical filter needs to be recycled may be determined by comparing the measured total time with the allowable purification time of the electrochemical filter.

In addition, the necessity of recycling the first electrochemical filter 121 and the second electrochemical filter 122 may be determined by a current value of purified water filtered by the first and second electrochemical filters 121 and 122.

Since an amount of ions contained in the purified water is in proportion to a current value, a point in time at which a current value of the purified water is equal to or greater than a reference value means that a large amount of ions exists in the purified water because water is not effectively purified.

Therefore, the point in time at which the current value of the purified water filtered by the electrochemical filter is equal to or greater than the reference value may be determined as the point in time at which the electrochemical filter needs to be recycled.

While the present invention has been shown and described in connection with the exemplary embodiments, it will be apparent to those skilled in the art that modifications and variations can be made without departing from the spirit and scope of the invention as defined by the appended claims.

1. A water treatment apparatus comprising:
a filter unit comprising a first electrochemical filter and a second electrochemical filter for filtering raw water; and
a control unit driving the first electrochemical filter and the second electrochemical filter,
wherein the first electrochemical filter and the second electrochemical filter are installed in parallel, and
wherein the control unit controls the second electrochemical filter to perform a water purifying operation when the first electrochemical filter needs to be recycled.

2. The water treatment apparatus of claim 1, wherein the control unit controls the first electrochemical filter to perform a water purifying operation when the second electrochemical filter needs to be recycled.

3. The water treatment apparatus of claim 1, wherein:
when the first electrochemical filter performs the recycling operation, the control unit controls the second electrochemical filter to perform the water purifying operation, and
when the first electrochemical filter completes the recycling operation, the control unit controls the first electrochemical filter to perform the water purifying operation.

4. The water treatment apparatus of claim 3, wherein the first electrochemical filter and the second electrochemical filter are configured such that the recycling of the second electrochemical filter has been completed while the first electrochemical filter performs the water purifying operation.

5-6. (canceled)

7. The water treatment apparatus of claim 1, further comprising:
a first outflow pipe through which water having passed through the first electrochemical filter is discharged;
a second outflow pipe through which water having passed through the second electrochemical filter is discharged;
a purified water pipe connected to the first outflow pipe and the second outflow pipe and through which the purified water flows; and
a drain pipe connected to the first outflow pipe and the second outflow pipe and through which waste water generated during the recycling of the electrochemical filter is discharged to the exterior.

8. The water treatment apparatus of claim 7, further comprising:
a first flow passage switch valve, provided at a branch point to which the first outflow pipe, the purified water pipe, and the drain pipe are connected, to selectively connect the first outflow pipe to the purified water pipe or the drain pipe; and
a second flow passage switch valve, provided at a branch point to which the second outflow pipe, the purified pipe, and the drain pipe are connected, to selectively connect the second outflow pipe to the purified water pipe or the drain pipe.

9. The water treatment apparatus of claim 8, wherein, when the first electrochemical filter performs the water purifying operation and the second electrochemical filter performs the recycling operation, the control unit switches a flow passage of the first flow passage switch valve such that water flowing out from the first outflow pipe is supplied to the purified water pipe, and switches a flow passage of the second flow passage switch valve such that water flowing out from the second outflow pipe is discharged to the drain pipe.

10. The water treatment apparatus of claim 8, wherein, when the second electrochemical filter performs the water purifying operation and the first electrochemical filter performs the recycling operation, the control unit switches a flow passage of the second flow passage switch valve such that water flowing out from the second outflow pipe is supplied to the purified water pipe, and switches a flow passage of the first flow passage switch valve such that water flowing out from the first outflow pipe is discharged to the drain pipe.

11. The water treatment apparatus of claim 8, wherein, when switching the water purifying operation and the recycling operation between the first electrochemical filter and the second electrochemical filter, the control unit performs a switching operation, such that the electrochemical filter performing the water purifying operation continues to perform the water purifying operation for a predetermined period of time, and the flow passage switch valve provided at the branch point of the outflow pipe connected to the electrochemical filter being recycled is switched in a direction of the purified water pipe after a preset period of time has elapsed, in order that waste water remaining in the outflow pipe connected to the electrochemical filter being recycled is discharged through the drain pipe.

12. The water treatment apparatus of claim 1, wherein, when the first electrochemical filter performs the recycling operation, the control unit supplies an amount of the purified water filtered by the second electrochemical filter to the first electrochemical filter for recycling the first electrochemical filter.

13. The water treatment apparatus of claim 12, further comprising:
a flow passage switch valve provided at a position from which a first connection pipe and a second connection pipe are branched, the first connection pipe being connected such that water is supplied to the first electrochemical filter, the second connection pipe being connected from the first connection pipe to the second electrochemical filter;
a first shut-off valve connected between the first connection pipe and a drain pipe;
a second shut-off valve connected between the second connection pipe and the drain pipe; and
a third shut-off valve and a fourth shut-off valve provided at a first outflow pipe connected to the first electrochemical filter and a second outflow pipe connected to the second electrochemical filter, respectively.

14. The water treatment apparatus of claim 13, wherein, when the first electrochemical filter performs the recycling operation, the control unit switches a flow passage of the flow passage switch valve such that water is supplied to the second connection pipe.

15. The water treatment apparatus of claim 14, wherein:
the control unit opens the first shut-off valve and closes the second shut-off valve, such that waste water generated during the recycling of the first electrochemical filter is discharged to the exterior through the drain pipe; and
the control unit opens the second shut-off valve and closes the first shut-off valve, such that water generated during the recycling of the second electrochemical filter is discharged to the exterior through the drain pipe.

16-20. (canceled)

21. The water treatment apparatus of claim 1, further comprising a first electrical conductivity sensor installed on a flow passage in a front end of the first and second electrochemical filters, and the control unit controls magnitudes of voltages applied to the first and second electrochemical filters, depending on a value measured by the first electrical conductivity sensor.

22. The water treatment apparatus of claim 1, further comprising a second electrical conductivity sensor installed on a water flow passage at a rear end of the first and second electrochemical filters, and the control unit controls magnitudes of voltages applied to the first and second electrochemical filters, depending on a value measured by the second electrical conductivity sensor.

23. The water treatment apparatus of claim 1, wherein the first and second electrochemical filters are implemented with capacitive deionization (CDI) cells.

24. A water treatment method for purifying raw water through a filter unit, including a first electrochemical filter and a second electrochemical filter installed in parallel, the water treatment method comprising:
supplying raw water to at least one of the first electrochemical filter and the second electrochemical filter;
determining whether the first electrochemical filter needs to be recycled;
when the first electrochemical filter needs to be recycled, controlling the first electrochemical filter to perform a recycling operation, and controlling the second electrochemical filter to perform a water purifying operation; and
when the first electrochemical filter does not need to be recycled, controlling the first electrochemical filter to perform a water purifying operation.

25. The water treatment method of claim 24, further comprising:
when the recycling of the first electrochemical filter has been completed, determining whether the second electrochemical filter needs to be recycled;
when the second electrochemical filter needs to be recycled, controlling the second electrochemical filter to perform a recycling operation, and controlling the first electrochemical filter to perform the water purifying operation; and
when the second electrochemical filter does not need to be recycled, controlling the first electrochemical filter to be in an idle state, and controlling the second electrochemical filter to continue to perform the water purifying operation.

26. The water treatment method of claim 24, further comprising:
when the first electrochemical filter is in the process of being recycled, determining whether the recycling of the first electrochemical filter has been completed;
when the recycling of the first electrochemical filter has been completed, controlling the first electrochemical filter to perform the water purifying operation, and controlling the second electrochemical filter to perform the recycling operation; and
when the recycling of the first electrochemical filter is not completed, controlling the first electrochemical filter to continue to perform the recycling operation, and controlling the second electrochemical filter to continue to perform the water purifying operation.

27-30. (canceled)
